(19) United States
(12) Patent Application Publication
(10) Pub. No.: US 2026/0039244 A1
(43) Pub. Date: Feb. 5, 2026

(54) ENERGY CONVERSION APPARATUS CAPABLE OF AUTOMATIC LIGHT COMPENSATION AND LIGHT RECYCLING

(71) Applicant: Zhongshan Amiray Technology Co., LTD., Zhongshan (CN)

(72) Inventor: Yiming Chen, Zhongshan (CN)

(21) Appl. No.: 19/357,129

(22) Filed: Oct. 14, 2025

Related U.S. Application Data
(63) Continuation of application No. PCT/CN2024/124482, filed on Oct. 12, 2024.

(30) Foreign Application Priority Data
Oct. 13, 2023 (CN) 202311329022.8
Jan. 29, 2024 (CN) 202410123094.5
Mar. 15, 2024 (CN) 202410297521.1

(51) Int. Cl. H02S 40/22; H02S 10/10; H02S 40/42

(52) U.S. Cl. CPC H02S 40/22; H02S 10/10; H02S 40/425

(57) ABSTRACT

Currently, photovoltaic power generation is increasingly applied outdoors, but most photovoltaic panels are arranged at a single tilt angle to receive sunlight. However, as the sun rises and sets, the angle of incident solar radiation changes, such that the photovoltaic panels receive limited effective sunlight, thereby resulting in low conversion efficiency. Disclosed in the present invention is an energy conversion apparatus capable of automatic light compensation and light recycling. The apparatus has a simple structure, and can perform light compensation on a photovoltaic unit, the light intensity on which is lower than a set value, in a photovoltaic module, in order to balance the light intensity received by each photovoltaic unit in the photovoltaic module, and can receive sunlight from different angles around the clock, so as to achieve the conversion output of the whole photovoltaic module, with high energy conversion efficiency.

### CROSS REFERENCE TO RELATED APPLICATIONS

The present application is a Continuation Application of PCT Application No. PCT/CN2024/124482 filed on Oct. 12, 2024, which claims the benefit of Chinese Patent Application Nos. 202311329022.8 filed on Oct. 13, 2023, 202410123094.5 filed on Jan. 29, 2024 and 202410297521.1 filed on Mar. 15, 2024. All the above are hereby incorporated by reference in their entirety.

### TECHNICAL FIELD

The present disclosure relates to the technical field of energy, and in particular to an energy conversion apparatus capable of automatic light compensation and light recycling. The present disclosure further relates to a control method for the energy conversion apparatus capable of automatic light compensation and light recycling.

### BACKGROUND

Currently, photovoltaic power generation is increasingly applied outdoors, but most photovoltaic panels are arranged at a single tilt angle to receive sunlight. However, as the sun rises and sets, the angle of incident solar radiation changes, such that the photovoltaic panels receive limited effective sunlight, thereby resulting in low conversion efficiency. Although some devices available on the market allow angle adjustment of photovoltaic panels to track solar movement, their structures are generally more complicated, and fail to fully absorb sunlight, that is, only part of the sunlight is absorbed and utilized. Therefore, there is a need for a photovoltaic unit that extensively absorbs sunlight for efficient energy conversion.

Additionally, during 10-14 hours from sunrise to sunset, sunlight intensities continuously vary. A certain luminance is required to activate photovoltaic panels, and to achieve optimal conversion efficiency of the photovoltaic panels, some requirements for the intensity and wavelength of sunlight are raised. Therefore, it is necessary to develop an energy conversion apparatus that performs light compensation when the sunlight intensity is insufficient at dawn or dusk or in slightly overcast weather, to ensure that photovoltaic panels achieve the optimal sunlight absorption efficiency.

Furthermore, regular cleaning of photovoltaic panels is required to maintain surface cleanliness and ensure optimal sunlight absorption. When the photovoltaic panels operate at excessively high temperatures, energy conversion is affected, and in this case, the photovoltaic panels need to be cooled through heat dissipation devices such as cooling fans and the like. Therefore, it is necessary to develop an energy conversion apparatus that enables cleaning and heat dissipation of photovoltaic panels to achieve the optimal sunlight absorption efficiency of the photovoltaic panels.

Additionally, currently, some devices combine wind power generation with solar power generation to supplement electric energy. During wind power generation, wind forces drive the fan blades to rotate, and then the rotation is accelerated through a speed-increasing gearbox to generate electricity through a generator. However, solar-wind hybrid power generation devices encounter difficulties in power supply under low-wind conditions.

Moreover, in addition to solar and wind energy, various natural resources such as hydraulic energy should be fully utilized according to geographic advantages of different regions, to convert various energy into electric energy.

The present disclosure is devised to address the above technical challenges.

### SUMMARY

In order to solve the technical problems, an objective of the present disclosure is to provide an energy conversion apparatus capable of automatic light compensation and light recycling. The apparatus has a simple structure, and can perform light compensation on a photovoltaic unit, the light intensity on which is lower than a set value, in a photovoltaic module in order to balance the light intensity received by each photovoltaic unit in the photovoltaic module, so as to achieve the conversion output of the whole photovoltaic module, with high energy conversion efficiency.

In order to solve the above technical problems, the present disclosure provides an energy conversion apparatus capable of automatic light compensation and light recycling, and the energy conversion apparatus includes at least a main pole and a plurality of light compensation modules, the main pole is provided with a plurality of photovoltaic modules along with a length thereof, each of the photovoltaic modules includes a plurality of photovoltaic units arranged around an outer side of the main pole, the photovoltaic units are configured to convert light energy into electric energy, the light compensation modules perform light compensation for the photovoltaic units of the photovoltaic modules where light intensity is lower than a preset threshold to balance the light intensity received by each of the photovoltaic units of the photovoltaic modules, the light compensation modules are electrically connected to a control system configured to control the light compensation modules to start the light compensation, and the photovoltaic units are electrically connected to the control system.

In the above energy conversion apparatus capable of automatic light compensation and light recycling, each of the photovoltaic units is arranged to tilt outward and upward, and an upper end of a lower photovoltaic unit is located on an inner side of a lower end of an upper photovoltaic unit.

In the above energy conversion apparatus capable of automatic light compensation and light recycling, the main pole is provided with assembly plates, a lower end of the photovoltaic unit is mounted on an assembly plate.

In the above energy conversion apparatus capable of automatic light compensation and light recycling, an upper end of the photovoltaic unit is directly or indirectly rotatably connected to the main pole, and the lower end of the photovoltaic unit is detachably mounted on the assembly plate.

In the above energy conversion apparatus capable of automatic light compensation and light recycling, the assembly plate of the upper photovoltaic unit is provided with at least one light compensation module configured to illuminate a front side of the lower photovoltaic unit to compensate light for the lower photovoltaic unit, a top of the main pole is provided with a top cover, and the top cover is provided with at least one light compensation module configured to illuminate the front side of the lower photovoltaic unit to achieve light compensation.

In the above energy conversion apparatus capable of automatic light compensation and light recycling, the photovoltaic unit equipped with the light compensation module is provided with at least a channel for the light emitted by the light compensation module to illuminate a reverse side thereof, the light compensation module is arranged on the reverse side of the photovoltaic unit and is configured to illuminate towards the reverse side of the photovoltaic unit, and the front side and reverse sides of the photovoltaic unit are both light-transmissive and absorb light energy and convert same into electric energy.

In the above energy conversion apparatus capable of automatic light compensation and light recycling, the front side of the photovoltaic unit is a light-transmissive glass plate, the reverse side of the photovoltaic unit is also a light-transmissive glass plate, and the cells of the photovoltaic unit are located between the glass plates; and alternatively, the front side of the photovoltaic unit is a light-transmissive glass plate, the reverse side of the photovoltaic unit is a light-transmissive film, and the cells of the photovoltaic unit are located between the glass plate and the film.

In the above energy conversion apparatus capable of automatic light compensation and light recycling, the photovoltaic module is correspondingly provided with photosensitive units configured to detect the light intensity received by each of the photovoltaic units, the light compensation module includes a plurality of LED lighting modules with different powers, and the control system is electrically connected to the photosensitive units and controls the light compensation module to emit light of corresponding light intensity according to the light intensity transmitted by the photosensitive units.

In the above energy conversion apparatus capable of automatic light compensation and light recycling, a gap is formed between two adjacent photovoltaic units, and a light guide assembly configured to refract light to the reverse side of the photovoltaic unit to achieve light absorption on the reverse side of the photovoltaic unit is mounted inside the gap, the light guide assembly includes at least a condensing lens or at least a light-directing lens configured to refract the light entering the gap to a reverse side of the double-sided glass plate of the photovoltaic unit, further including a frame, where the photovoltaic unit and the light guide assembly are fixed to the frame, and each light guide assembly is provided with a light-receiving surface exposed from the left and right sides of the photovoltaic unit to receive light incident from the gap between the left and right photovoltaic units.

In the above energy conversion apparatus capable of automatic light compensation and light recycling, the photovoltaic unit is attached and fixed to a surface of the main pole.

In the above energy conversion apparatus capable of automatic light compensation and light recycling, the main pole has an integrated structure.

In the above energy conversion apparatus capable of automatic light compensation and light recycling, the main pole is assembled from a number of pole segments fitted together end-to-end, an outer side face of the pole segment is provided with at least a mounting frame, and the photovoltaic unit is mounted on the mounting frame.

In the above energy conversion apparatus capable of automatic light compensation and light recycling, each of the pole segments has a conical structure enlarged from top to bottom, an upper end of the lower pole segment is inserted into a bottom hole of an upper pole segment, and the mounting frames of the upper and lower pole segments are fixed by screws after sleeved connection.

In the above energy conversion apparatus capable of automatic light compensation and light recycling, the upper and lower ends of a plurality of the photovoltaic units in one same layer are provided with connectors for connecting and fixing the plurality of the photovoltaic units to form one photovoltaic module, a middle part of the photovoltaic module is provided with a through hole into which the main pole is sleeved, and the main pole is vertically sleeved with a plurality of the photovoltaic modules.

In the above energy conversion apparatus capable of automatic light compensation and light recycling, at least a side of the photovoltaic unit is detachably provided with at least a reinforcement strip configured to press the photovoltaic unit against falling off.

The above energy conversion apparatus capable of automatic light compensation and light recycling further includes at least a ventilation and exhaust mechanism and a battery pack, where the ventilation and exhaust mechanism includes at least a first air duct arranged on an inner side of the photovoltaic unit, and the first air duct is provided with at least a first air vent configured to blow wind toward an inner surface of the photovoltaic unit. The ventilation and exhaust mechanism further includes an air compressor connected to the first air duct and an air storage tank configured to store the air discharged by the air compressor, the air storage tank is provided with an electric valve configured to discharge the air in the air storage tank to the first air duct; an outer side of the photovoltaic unit is provided with a first wind power generation device, and the inner side of the photovoltaic unit is provided with at least a second wind power generation device configured to generate electricity by using the wind blown from of the first air vent; the energy conversion apparatus further includes a control system configured to control the air compressor to store air into the air storage tank and control opening of the electric valve to release the air in the air storage tank, and the air compressor and the electric valve are electrically connected to the control system.

In the above energy conversion apparatus capable of automatic light compensation and light recycling, at least a water collection gutter and at least a water storage tank configured to collect water are arranged below the photovoltaic unit, the water collection gutter is higher than the water storage tank, at least a water inlet pipe configured to discharge water in the water collection gutter to the water storage tank is arranged between the water collection gutter and the water storage tank, and the water inlet pipe is provided with at least a hydroelectric generator.

In the above energy conversion apparatus capable of automatic light compensation and light recycling, the air compressor is provided with a water-gas separator, and water separated by the water-gas separator flows into the water storage tank through a conduit.

In the above energy conversion apparatus capable of automatic light compensation and light recycling, the ventilation and exhaust mechanism further includes a second air duct located outside the photovoltaic unit and connected to an air outlet of the electric valve, the second air duct is provided with at least a second air vent that blows wind toward an outer surface of the photovoltaic unit, a drainage pipe connecting the water storage tank and the second air duct is provided therebetween, and the drainage pipe is provided with a water pump configured to pump water from the water storage tank to the second air duct.

To solve another technical problem, a control method for the energy conversion apparatus capable of automatic light compensation and light recycling is provided. By means of the method, the apparatus has a simple structure, can automatically adjust light compensation such that photovoltaic units can achieve the optimal conversion efficiency during operation and obtain effective electric energy by means of conversion, and has the features of high energy conversion efficiency and stable and reliable use.

To solve the above technical problems, a control method for the energy conversion apparatus capable of automatic light compensation and light recycling is provided;
the photovoltaic module is correspondingly provided with a photosensitive unit configured to detect the light intensity received by each photovoltaic unit, and the control system is electrically connected to the photovoltaic module, the light compensation modules, and the photosensitive unit, and controls the photovoltaic module, the light compensation modules, and the photosensitive unit to operate;
the photosensitive unit transmits a detected light intensity signal to the control system;
when the photovoltaic module receives a certain amount of sunlight, but the light intensities received by all photovoltaic units are lower than a preset light activation threshold A, the control system controls the light compensation modules corresponding to the photovoltaic units in the photovoltaic module to operate such that the light intensity received by each of the photovoltaic units in the photovoltaic module reaches the light activation threshold A; the light activation threshold A is greater than a minimum light intensity required for the photovoltaic units to operate, and is less than a conversion light intensity B required for the photovoltaic units to achieve a conversion rate m;
when the light intensity received by some photovoltaic units in the photovoltaic module is lower than the preset light activation threshold A, while the light intensity received by other photovoltaic units is equal to or greater than the light activation threshold A, the control system controls the corresponding light compensation modules to perform light compensation for the photovoltaic units with the light intensity lower than the light activation threshold A; and
when the light intensities received by all the photovoltaic units in the photovoltaic module are greater than the preset light activation threshold A, but the light intensities received by some or all of the photovoltaic units are less than the conversion light intensity B required for the photovoltaic units to achieve the conversion rate m, the control system controls the corresponding light compensation module to perform light compensation for the photovoltaic units with the light intensity lower than the preset conversion light intensity B, such that the light intensity received by each of the photovoltaic units in the photovoltaic module reaches the preset conversion light intensity B.

According to the control method for energy conversion apparatus capable of automatic light compensation and light recycling, the photovoltaic unit equipped with the light compensation module is mounted is provided with at least a channel for the light emitted by the light compensation module to irradiate a reverse side thereof, the light compensation module is arranged on the reverse side of the photovoltaic unit and irradiates the reverse side of the photovoltaic unit, the light compensation module also illuminates a front side of the lower photovoltaic unit, and in a predetermined time period at night, the control system controls the light compensation module to operate, and the front and reverse sides of the photovoltaic unit are both light-transmissive and absorb the light emitted by the light compensation module for conversion into electric energy; and part of the light emitted by the light compensation module is transmitted out of the photovoltaic unit through areas not covered by cells of the photovoltaic unit.

According to the control method for energy conversion apparatus capable of automatic light compensation and light recycling, the energy conversion apparatus further includes at least a ventilation and exhaust mechanism and a battery pack, where the ventilation and exhaust mechanism includes at least a first air duct arranged on an inner side of the photovoltaic unit, and the first air duct is provided with at least a first air vent configured to blow wind toward an inner surface of the photovoltaic unit; the ventilation and exhaust mechanism further includes an air compressor connected to the first air duct and an air storage tank configured to store the air discharged by the air compressor, the air storage tank is provided with an electric valve configured to discharge the air in the air storage tank to the first air duct; an outer side of the photovoltaic unit is provided with a first wind power generation device, and the inner side of the photovoltaic unit is provided with at least a second wind power generation device configured to generate electricity by using the wind blown from of the first air vent; the energy conversion apparatus further includes a control system configured to control the air compressor to store air into the air storage tank and controls opening of the electric valve to release the air in the air storage tank, and the air compressor and the electric valve are electrically connected to the control system;
the first wind power generation device (6) is provided with at least a wind speed sensor configured to detect the ambient wind speed, the wind speed sensor is electrically connected to the control system;
light received by the photovoltaic units is converted into electric energy and stored in the battery pack, and wind energy is converted into electric energy by the first wind power generation device and stored in the battery pack; the battery pack supplies electrical power to the air compressor and the electric valve, and the control system controls the air compressor to compress and store air in the air storage tank; and
the first wind power generation device and the second wind power generation device are both breeze-start wind turbines, when the wind speed sensor detects that the ambient wind speed is lower than a preset threshold, the control system controls opening of the electric valve to release the compressed air in the air storage tank and blow toward the first wind power generation device, such that the first wind power generation device supplements electric energy for the battery pack; and fan blades of the second wind power generation device are driven to rotate by the wind blown out from the first air vent to generate electricity to be stored in the battery pack.

According to the control method for energy conversion apparatus capable of automatic light compensation and light recycling, at least a water collection gutter and a water storage tank configured to collect water are arranged below the photovoltaic unit, the water collection gutter is higher than the water storage tank, at least a water inlet pipe configured to discharge water in the water collection gutter to the water storage tank is arranged between the water collection gutter and the water storage tank, and the water inlet pipe is provided with at least a hydroelectric generator; configured to collect atmospheric precipitation through the water collection gutter arranged below the photovoltaic unit, and when the water in the water inlet pipe flows to the water storage tank, the water flow drives the hydroelectric generator to rotate, and the hydroelectric generator generates electric energy to be stored in the battery pack; and
the air compressor is provided with a water-gas separator is arranged on the air compressor, and water separated by the water-gas separator from intake air flows into the water storage tank through a conduit.

According to the control method for energy conversion apparatus capable of automatic light compensation and light recycling, the ventilation and exhaust mechanism further includes a second air duct located outside the photovoltaic unit and connected to an air outlet of the electric valve, the second air duct is provided with at least a second air vent that blows wind toward an outer surface of the photovoltaic unit, a drainage pipe connecting the water storage tank and the second air duct is arranged therebetween, the drainage pipe is provided with a water pump configured to pump water from the water storage tank to the second air duct, and the battery pack supplies electrical power to the water pump; the control system directly controls opening of the electric valve to release the compressed air in the air storage tank and blow toward the outer surface of the photovoltaic unit through the second air vent for cleaning; alternatively, the control system controls the water pump to draw water from the water storage tank into the second air duct, cooperating with the compressed air released from the air storage tank to blown toward the outer surface of the photovoltaic unit for cleaning; and
the energy conversion apparatus further includes a timer, the timer is electrically connected to the control system, and when a preset time interval of the timer expires, the control system controls opening of the electric valve to release the compressed air in the air storage tank and blow toward the outer side of the photovoltaic unit through the second air duct for cleaning.

According to the control method for energy conversion apparatus capable of automatic light compensation and light recycling, the photovoltaic unit is provided with at least a temperature sensor configured to, connect to the control system electrically, and when the temperature sensor detects that the temperature reaches a preset threshold, the control system controls opening of the electric valve to release the compressed air in the air storage tank and blow out from the first air vent to perform heat dissipation for the photovoltaic unit; and the second wind power generation device receives the wind blown out from the first air vent to generate electricity to be stored in the battery pack.

According to the control method for energy conversion apparatus capable of automatic light compensation and light recycling, the photovoltaic unit is provided with at least a dust sensor, connected to the control system electrically, and when the dust sensor detects that the dust level reaches a preset threshold, the control system controls opening of the electric valve to release the compressed air in the air storage tank and blow out from the second air vent to clean the photovoltaic unit;
when the dust sensor detects that the dust level reaches the preset threshold, the control system controls opening of the electric valve to release the compressed air in the air storage tank and blow toward the photovoltaic unit from the second air vent, and controls the water pump to pump water from the water storage tank into the second air duct, cooperating the compressed air released from the air storage tank to blown toward the outer surface of the photovoltaic unit for cleaning; and
the water used for cleaning the photovoltaic unit flows into the water collection gutter along the surface of the photovoltaic unit, the water in the water collection gutter flows to the water storage tank through the water inlet pipe, the water flow drives the hydroelectric generator to rotate, and the hydroelectric generator generates electric energy to be stored in the battery pack.

Compared with the prior art, the present disclosure has the beneficial effects as follows:
1. In the columnar energy conversion apparatus of the present disclosure, the photovoltaic units are distributed around the main pole in a circumferential direction and receive sunlight from different angles around the clock, the light intensity of sunlight is different at different times of the day, for example, the light intensity of sunlight at dawn and dusk is relatively weak and insufficient to activate the photovoltaic units, therefore, the light compensation module is arranged to supplement the light intensity of some light received by the photovoltaic units such that the light intensity reaches the preset threshold for starting the energy conversion, and the sunlight originally without conversion efficiency is converted into effective electric energy after the light compensation; in some periods, sunlight only irradiates the photovoltaic units on one side of the main pole, and the photovoltaic units on the other side of the main pole have weak or insufficient light illuminance, resulting in significant differences in voltage or current output by the photovoltaic units located at different positions in the photovoltaic module, as well as low conversion efficiency of all the photovoltaic modules, and therefore the light compensation module is configured to perform light compensation to balance the light intensity received by each of the photovoltaic units in the photovoltaic module, such that all the photovoltaic modules operate efficiently and the solar energy conversion rate is improved.
2. An upper end of the photovoltaic unit of the present disclosure is directly or indirectly rotatably connected to the main pole, a lower end of the photovoltaic unit is detachably mounted on the assembly plate, and the photovoltaic unit is flipped outward and opened, thereby facilitating maintenance.
3. When the energy conversion apparatus capable of automatic light compensation and light recycling of the present disclosure performs light compensation, the photosensitive unit transmits a detected light intensity signal to the control system, and during different periods of the day, the control system controls the light compensation module to activate a variety of light compensation modes according to the light intensities received by the photovoltaic units, thereby achieving efficient energy conversion.
4. For the energy conversion apparatus capable of automatic light compensation and light recycling of the present disclosure, in the predetermined time period at night, the control system directly controls the light compensation module to achieve nighttime illumination. The light emitted downward by the light compensation module is used for nighttime illumination, the lower photovoltaic units also perform recycling of illuminating rays, the light directed to the reverse side of the photovoltaic unit is recycled by the photovoltaic unit, and part of the light is transmitted out of the photovoltaic unit through areas not covered by cells of the photovoltaic unit, thereby achieving an artistic landscape effect.
5. The photovoltaic units of the present disclosure are attached and fixed to the surface of the main pole or connected and fixed through connectors to form the photovoltaic module, and further sleeved on the main pole. Attached or sleeved connection of the photovoltaic unit is not adversely affected by environmental factors such as strong wind or heavy rain, thereby ensuring stable and reliable use. Additionally, the main pole is alternatively elongated but occupies a small area, and receives light energy all the time from sunrise to sunset. Arrangement depends on the surrounding environment, and for example, when one side of the main pole is obstructed by a building or a tree, the photovoltaic units are arranged only on the unobstructed side of the main pole.
6. The main pole is formed by vertically connecting a plurality of pole segments in a sleeved manner, and a mounting frame is arranged on an outer side face of the pole segment, and the photovoltaic unit is mounted on the mounting frame. Each of the pole segments has a conical structure enlarged from top to bottom, an upper end of the lower pole segment is inserted into a bottom hole of the upper pole segment, and the mounting frames of the upper and lower pole segments are fixed by screws after sleeved connection, thereby achieving convenient assembly and stable and reliable use.
7. A reinforcement strip configured to press and prevent the photovoltaic unit from falling is detachably mounted on a side edge of the photovoltaic unit. The reinforcement strip is arranged to prevent the photovoltaic units from being blown off by a super typhoon. The reinforcement strip may be simultaneously pressed on side edges of two adjacent photovoltaic units.
8. The present disclosure generates electricity through wind energy, and also pre-stores wind energy in the air storage tank, and when external wind energy is insufficient, the compressed air in the air storage tank is released to blow toward the second wind power generation device for electricity generation.
9. In the present disclosure, the water collection gutter and the water storage tank configured to collect water are arranged below the photovoltaic unit, the hydroelectric generator is arranged on the water inlet pipe to collect rainwater during rainy days for power generation, the water in the water storage tank is introduced into the second air duct and blown toward the photovoltaic unit together with the air released from the air storage tank to clean the surface of the photovoltaic unit, the water-gas separator is arranged on the air compressor, water separated by the water-gas separator from the compressed air flows into the water storage tank through a conduit, and rainwater and cleaning water are also stored in the water storage tank through the water collection gutter for recycling.
10. In the present disclosure, when the temperature sensor detects that the temperature reaches the preset threshold, the control system controls opening of the electric valve to release the compressed air in the air storage tank to cool the photovoltaic unit, and during cooling, electric energy is supplemented through the second wind power generation device.

### BRIEF DESCRIPTION OF THE DRAWINGS

FIG. 1 is a schematic structural diagram of an energy conversion apparatus capable of automatic light compensation and light recycling according to the present disclosure.

FIG. 2 is a schematic diagram of an internal structure of an energy conversion apparatus capable of automatic light compensation and light recycling of the present disclosure with a photovoltaic unit opened.

FIG. 3 is a front view of an energy conversion apparatus capable of automatic light compensation and light recycling of the present disclosure.

FIG. 4 is a sectional view of FIG. 3 of the present disclosure.

FIG. 5 is a schematic structural diagram of a photovoltaic unit mounted on an assembly plate according to the present disclosure.

FIG. 6 is a schematic structural diagram of a photovoltaic unit mounted on an assembly plate according to another embodiment of the present disclosure.

FIG. 7 is a schematic structural diagram of a second energy conversion apparatus according to an embodiment of the present disclosure.

FIG. 8 is a top view of the energy conversion apparatus shown in FIG. 7 according to an example of the present disclosure.

FIG. 9 is a schematic structural diagram of a photovoltaic module according to an embodiment of the present disclosure.

FIG. 10 is a sectional view of the photovoltaic module shown in FIG. 9 according to the present disclosure.

FIG. 11 is a schematic structural diagram of an energy conversion apparatus according to an example of the present disclosure in which a main pole is hexagonal.

FIG. 12 is a sectional view of an energy conversion apparatus according to an example of the present disclosure in which a main pole has an integrated structure.

FIG. 13 is a schematic structural diagram of a main pole of a split structure according to an embodiment of the present disclosure.

FIG. 14 is a schematic structural diagram of a light guide assembly according to a first embodiment of the present disclosure.

FIG. 15 is a schematic structural diagram of a light guide assembly according to a second embodiment of the present disclosure.

FIG. 16 is a schematic structural diagram of a photovoltaic unit and a light guide assembly fixed to a frame according to the present disclosure.

FIG. 17 is a side view of a photovoltaic unit and a light guide assembly according to the present disclosure.

FIG. 18 is a schematic structural diagram of a main pole of an integrated structure according to an embodiment of the present disclosure.

FIG. 19 is a schematic structural diagram of a triangular main pole according to an example of the present disclosure.

FIG. 20 is a schematic structural diagram of a quadrilateral main pole according to an example of the present disclosure.

FIG. 21 is a schematic structural diagram of a pentagonal main pole according to an example of the present disclosure.

FIG. 22 is a schematic structural diagram of a photovoltaic unit with a reinforcement strip mounted according to the present disclosure.

FIG. 23 is a schematic structural diagram I of a third energy conversion apparatus according to an embodiment of the present disclosure.

FIG. 24 is a schematic structural diagram II of FIG. 23.

FIG. 25 is a schematic sectional view of FIG. 23.

FIG. 26 is a schematic structural diagram of a photovoltaic unit, an assembly plate, and a second wind power generation device according to the present disclosure.

FIG. 27 is a schematic structural diagram of a bottom of a third energy conversion apparatus of the present disclosure.

FIG. 28 is a schematic diagram of pipelines of a first air duct, a second air duct, a drainage pipe, and a water inlet pipe according to the present disclosure.

### DETAILED DESCRIPTIONS OF THE EMBODIMENTS

Specific examples of the present disclosure will be described in detail herein. Preferred examples of the present disclosure are illustrated in the accompanying drawings, and the accompanying drawings are intended to graphically supplement the written description in the specification and enable the visual and intuitive understanding of each technical feature and the overall technical solution of the present disclosure. However, the accompanying drawings shall not be construed as limiting the protection scope of the present disclosure.

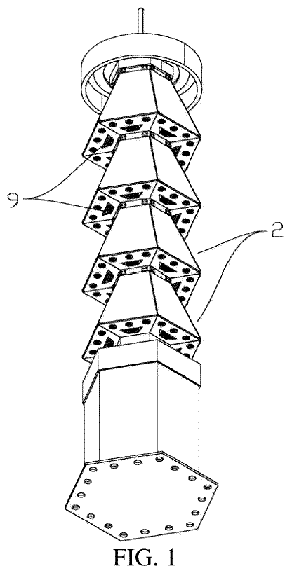

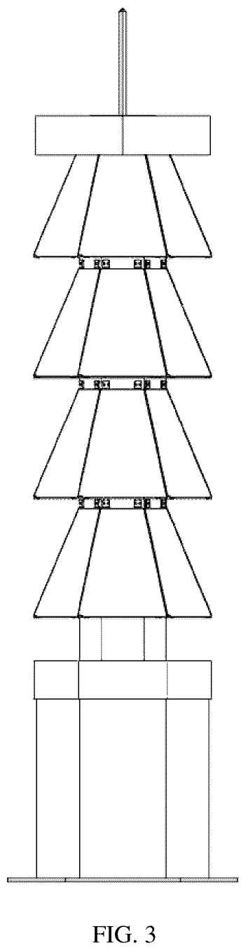

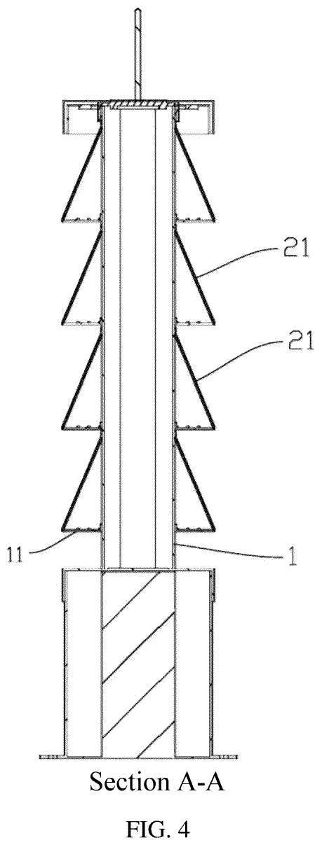

As shown in FIGS. 1-5, an energy conversion apparatus capable of automatic light compensation and light recycling includes at least a main pole 1 and a plurality of light compensation modules 9, the main pole 1 is provided with a plurality of photovoltaic modules 2 along with a length thereof, each of the photovoltaic modules 2 includes a plurality of photovoltaic units 21 arranged around an outer side of the main pole 1, the photovoltaic units 21 are configured to convert light energy into electric energy, the light compensation modules 9 perform light compensation for photovoltaic units 21 of the photovoltaic modules 2 where light intensity is lower than a predetermined threshold to balance the light intensity received by each of the photovoltaic units 21 of the photovoltaic modules 2, the light compensation modules 9 are electrically connected to a control system configured to control the light compensation modules to start the light compensation, and the photovoltaic units 21 are electrically connected to the control system. In the columnar energy conversion apparatus, the photovoltaic units are distributed around the main pole 1 in a circumferential direction and receive sunlight from different angles around the clock, the light intensity of sunlight is different at different times of the day, for example, the light intensity of sunlight at dawn and dusk is relatively weak and insufficient to activate the photovoltaic units, therefore, and the light compensation modules 9 are arranged to supplement the light intensity of some light received by the photovoltaic units such that the light intensity reaches the predetermined threshold for starting the energy conversion, and the sunlight originally without conversion efficiency is converted into effective electric energy after the light compensation; in some periods, sunlight only irradiates the photovoltaic units on one side of the main pole 1, and the photovoltaic units on the other side of the main pole 1 have weak or insufficient light illuminance, resulting in significant differences in voltage or current output by the photovoltaic units located at different positions in the photovoltaic module, as well as low conversion efficiency of all the photovoltaic modules, and therefore the light compensation modules 9 are configured to perform light compensation to balance the light intensity received by each of the photovoltaic units 21 in the photovoltaic modules 2, such that all the photovoltaic modules operate efficiently and the solar energy conversion rate is improved.

Preferably, each of the photovoltaic module 2 is correspondingly provided with photosensitive units configured to detect the light intensity received by each of the photovoltaic units 21, and the control system is electrically connected to the photosensitive unit and controls the light compensation modules 9 to emit light of corresponding light intensity according to the light intensity transmitted by the photosensitive unit. The photosensitive unit includes a light intensity sensor, and the like. To facilitate deployment through the control system, the light compensation module generates a radiation wavelength emulating the solar radiation spectrum, and the light illuminance is supplemented by LED lighting modules of different powers to achieve the predetermined light intensity, such that the light is supplemented as soon as possible to realize light energy conversion. The light compensation modules 9 include a plurality of LED lighting modules with different powers. Alternatively, the light compensation module includes a plurality of LED lighting modules capable of illuminating different positions of the lower photovoltaic units 21.

Further, in order to facilitate ventilation and heat dissipation and ensure that the photovoltaic modules maintain high-efficiency operation during the light energy conversion, a plurality of heat dissipation fans are mounted on the main pole 1 or an assembly plate 11.

Each of the photovoltaic units 21 is arranged to tilt outward and upward, and an upper end of a lower photovoltaic unit 21 is located on an inner side of a lower end of an upper photovoltaic unit 21. The assembly plates 11 main pole 1 is provided with assembly plates 11, and a lower end of the photovoltaic unit 21 is mounted on an assembly plate 11. The assembly plate has a polygonal plate structure, and the photovoltaic units and the polygonal assembly plate are assembled and spliced to form a polygonal photovoltaic module, such as a hexagonal photovoltaic module composed of six photovoltaic units. An upper end of the photovoltaic unit 21 is directly or indirectly rotatably connected to the main pole 1, that is, the upper end of the photovoltaic unit 21 is directly mounted on the main pole 1, or the upper end of the photovoltaic unit is rotatably connected to a crossbar added on the main pole, and the lower end of the photovoltaic unit 21 is detachably mounted on an assembly plate 11. The upper and lower ends of the photovoltaic unit are mounted by means of hinges, as shown in FIG. 6. In this way, the photovoltaic unit is flipped outward and opened, thereby facilitating maintenance. A bracket is made from a light-transmissive or non-light-transmissive material. The main pole 1 has a cylindrical or N-sided polygonal structure, where N is greater than or equal to 3.

The photovoltaic modules of the present disclosure are minimally affected by environmental factors. For example, in cloudy and rainy weather with the insufficient light intensity, light compensation is performed to achieve the required light intensity for energy conversion, thereby ensuring stable and reliable use. Additionally, the main pole is alternatively elongated but occupies a small area, and receives light energy all the time from sunrise to sunset. Arrangement depends on the surrounding environment, and for example, when one side of the main pole is obstructed by a building or a tree, the photovoltaic units are arranged only on the unobstructed side of the main pole.

The assembly plate 11 of the upper photovoltaic unit 21 is provided with at least one light compensation module 9 configured to illuminate a front side of the lower photovoltaic unit 21 to compensate light for the lower photovoltaic unit 21. For the top photovoltaic unit, a top of the main pole 1 is provided with a top cover 5, and the top cover 5 is provided with at least one light compensation module 9 configured to illuminate the front side of the lower photovoltaic unit 21 to achieve light compensation. The top cover is tightly fixed on the main pole by means of screws.

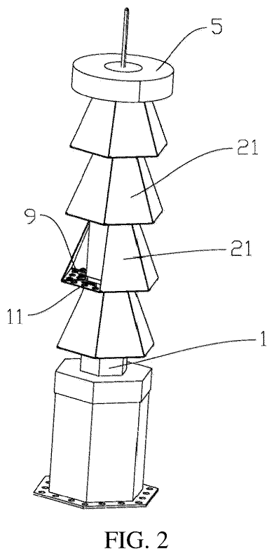

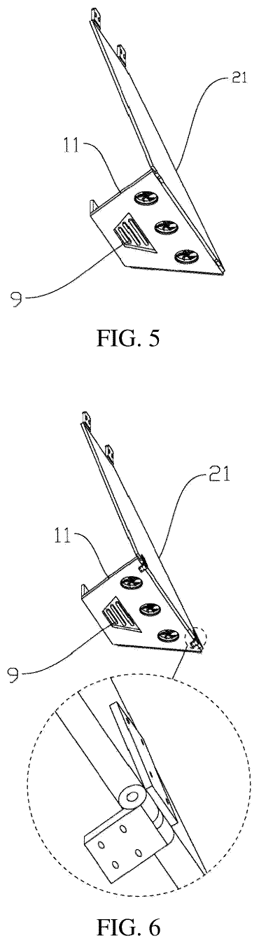

As shown in FIGS. 2 and 5, the photovoltaic unit 21 equipped with the light compensation module 9 is provided with at least a channel for the light emitted by the light compensation module 9 to illuminate a reverse side thereof, the light compensation module 9 is arranged on the reverse side of the photovoltaic unit 21 and is configured to illuminate towards the reverse side of the photovoltaic unit 21, and front side and reverse side of the photovoltaic unit 21 are both light-transmissive and absorb light energy and convert same into electric energy. When the light is illuminated toward the reverse side of the photovoltaic unit, the light is transmitted from areas not obstructed by cells of the photovoltaic unit, such as blank areas around the photovoltaic unit, and gaps between all the cells, such that the effect of artistic landscape at night is achieved, and secondary light recycling is achieved because the reverse side of the photovoltaic unit also absorbs light.

The front side of the photovoltaic unit 21 is a light-transmissive glass plate, the reverse side of the photovoltaic unit 21 is also a light-transmissive glass plate, and the cells of the photovoltaic unit 21 are located between the glass plates; and alternatively, the front side of the photovoltaic unit 21 is a light-transmissive glass plate, the reverse side of the photovoltaic unit 21 is a light-transmissive film, and the cells of the photovoltaic unit 21 are located between the glass plate and the film.

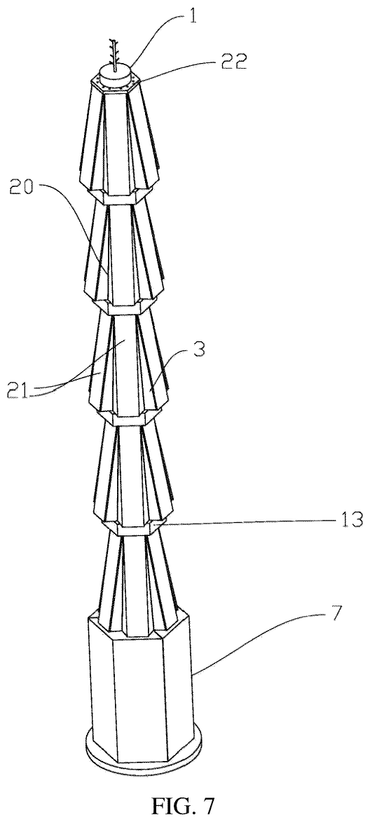

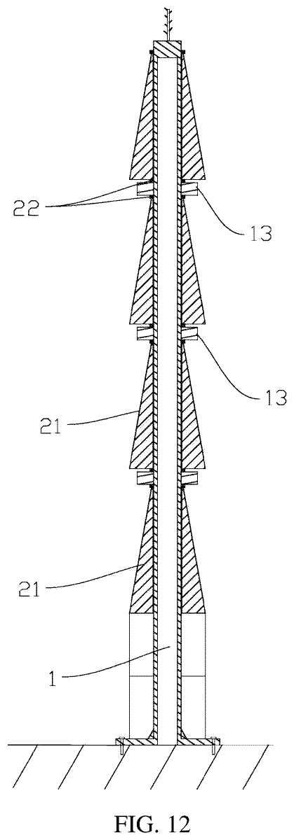

In an embodiment, as shown in FIGS. 7, 8, 11, and 12, a gap 20 may be formed between two adjacent photovoltaic units 21, and a light guide assembly 3 configured to refract light to the reverse side of the photovoltaic unit 21 to achieve light absorption on the reverse side of the photovoltaic unit 21 is mounted inside the gap 20. When the photovoltaic unit of the present disclosure is a light-transmissive double-sided glass plate and the light guide assembly is arranged inside in the gap, both the front and reverse sides of the cells of the photovoltaic unit absorb light, such that an overall light absorption rate of the photovoltaic unit is high, and the energy conversion efficiency is high.

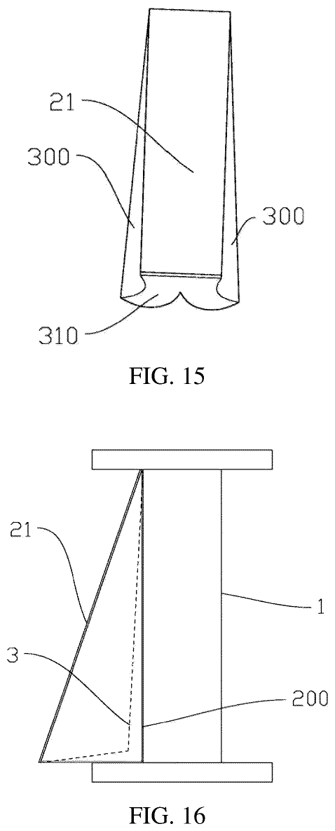

As shown in FIGS. 14 and 15, the light guide assembly 3 includes at least a condensing lens 310 or at least a light-directing lens 311 configured to refract the light entering the gap 20 to a reverse side of the double-sided glass plate of the photovoltaic unit 21. The lens is a convex lens or a concave lens. The lens is mounted inside the gap, such that each of the photovoltaic units has lens on both left and right sides thereof, thereby achieving bidirectional light condensation or bidirectional light guidance, and increasing the amount of light entering the reverse side of the photovoltaic unit.

The photovoltaic unit and the light guide assembly have a split structure or an integrated structure.

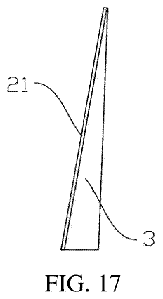

Preferably, as shown in FIGS. 16 and 17, the energy conversion apparatus further includes a frame 200, the photovoltaic unit 21 and the light guide assembly 3 are fixed on the frame 200, and each light guide assembly 3 is provided with a light-receiving surface 300 exposed from the left and right sides of the photovoltaic unit 21 to receive light incident from the gap 20 between the left and right photovoltaic units 21.

The photovoltaic unit of the present disclosure is fixed through various means, with details as follows:

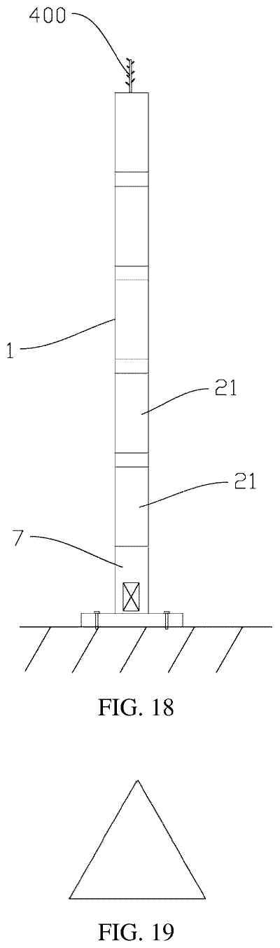

As one of the embodiments for fixing the photovoltaic unit of the present disclosure, the photovoltaic unit 21 is attached and fixed to a surface of the main pole 1, as shown in FIG. 18.

The photovoltaic units are encapsulated on the surface of the main pole 1, the main pole has various structures, and various embodiments are listed below:

Example 1: The main pole 1 is of an integrated structure, and as shown in FIG. 18, and the photovoltaic unit 21 is encapsulated on an outer wall of the main pole 1.

As shown in FIG. 18, in order to prevent lightning strikes from affecting the energy conversion apparatus, a lightning arrester 400 is mounted at an upper end of the main pole.

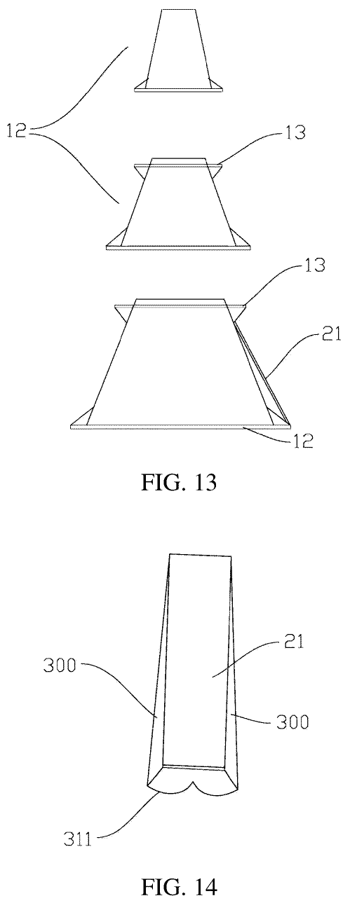

Example 2: The main pole 1 is assembled from a number of pole segments 12 fitted together end-to-end, and as shown in FIG. 13, an outer side face of the pole segment 12 is provided with at least a mounting frame 13, and the photovoltaic unit 21 is mounted on the mounting frame 13. Further, each of the pole segments 12 has a conical structure enlarged from top to bottom, an upper end of the lower pole segment 12 is inserted into a bottom hole of the upper pole segment 12, and the mounting frames of the upper and lower pole segments 12 are fixed by screws after sleeved connection. Convenient assembly and stable and reliable use are achieved.

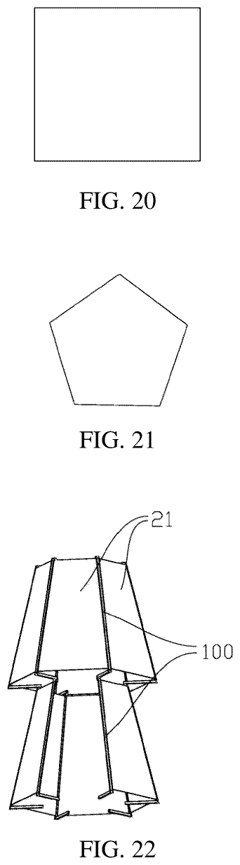

As shown in FIGS. 19-21, the main pole 1 is further designed to have a polygonal structure such as a triangular structure, a quadrilateral structure, or a pentagonal structure.

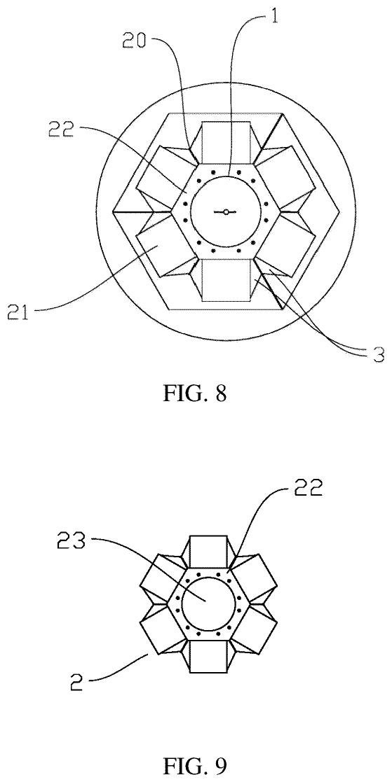

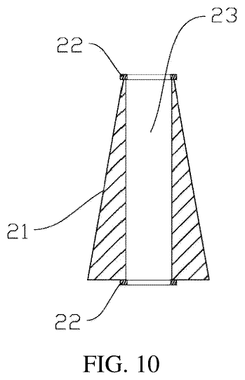

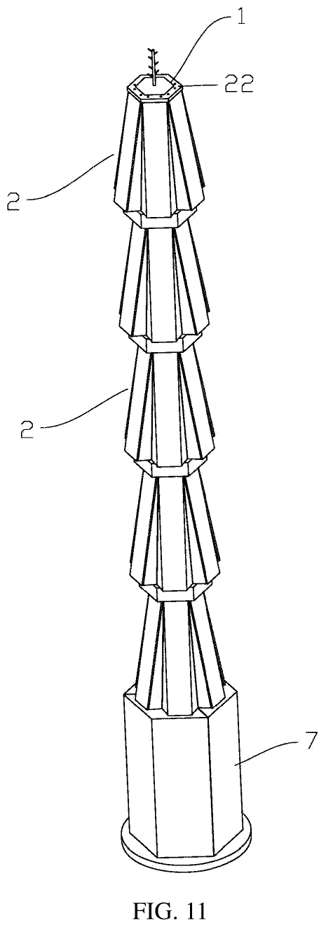

Another embodiment for fixing the photovoltaic unit: the photovoltaic unit is fixed to the main pole in a sleeved manner, and as shown in FIGS. 7-12, specifically, the upper and lower ends of a plurality of the photovoltaic units 21 in one layer are provided with connectors 22 for connecting and fixing the plurality of the photovoltaic units 21 to form one photovoltaic module 2, a middle part of the photovoltaic module 2 is provided with a through hole 23 into which the main pole 1 is sleeved, and the main pole 1 is vertically sleeved with a plurality of the photovoltaic modules 2. During installation, the photovoltaic module is threadedly fixed to the main pole by means of the connectors at the upper and lower ends thereof. The photovoltaic module is sleeved on the main pole, the main pole is arranged to be circular, as shown in FIGS. 7 and 8, and alternatively, the main pole is polygonal, i.e., triangular, quadrilateral, pentagonal, or hexagonal, as shown in FIG. 11. The connectors of the photovoltaic module are adaptively configured to match the shape of the main pole.

When the photovoltaic units of the present disclosure are attached and fixed to the surface of the main pole or sleeved on the main pole, the photovoltaic units are vertically arranged around the main pole from top to bottom layer by layer, or a plurality of the photovoltaic units are horizontally arranged along the main pole, which is not adversely affected by environmental factors such as strong wind or heavy rain, thereby ensuring stable and reliable use. Additionally, the main pole is alternatively elongated but occupies a small area, and receives light energy all the time from sunrise to sunset. Arrangement depends on the surrounding environment, and for example, when one side of the main pole is obstructed by a building or a tree, the photovoltaic units are arranged only on the unobstructed side of the main pole.

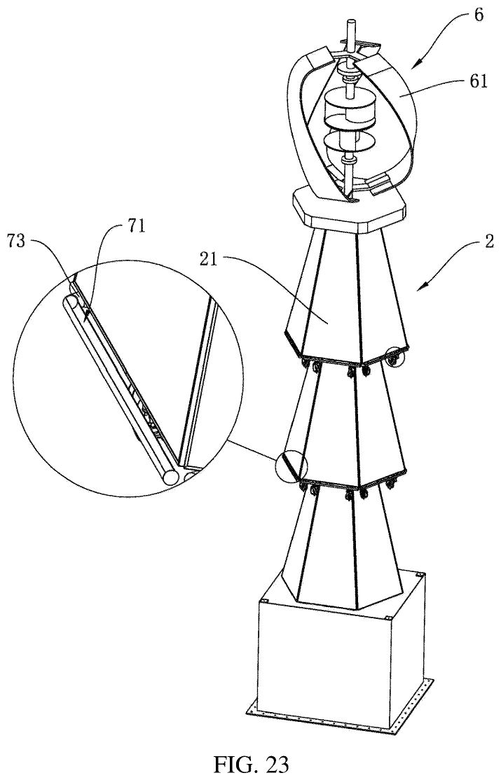

In an embodiment, as shown in FIG. 22, at least a side of the photovoltaic unit 21 is detachably provided with at least a reinforcement strip 100 configured to press the photovoltaic unit 21 against falling off. The reinforcement strip 100 is arranged to prevent the photovoltaic units from being blown off by a super typhoon. The reinforcement strip 100 may be simultaneously pressed on side edges of two adjacent photovoltaic units.

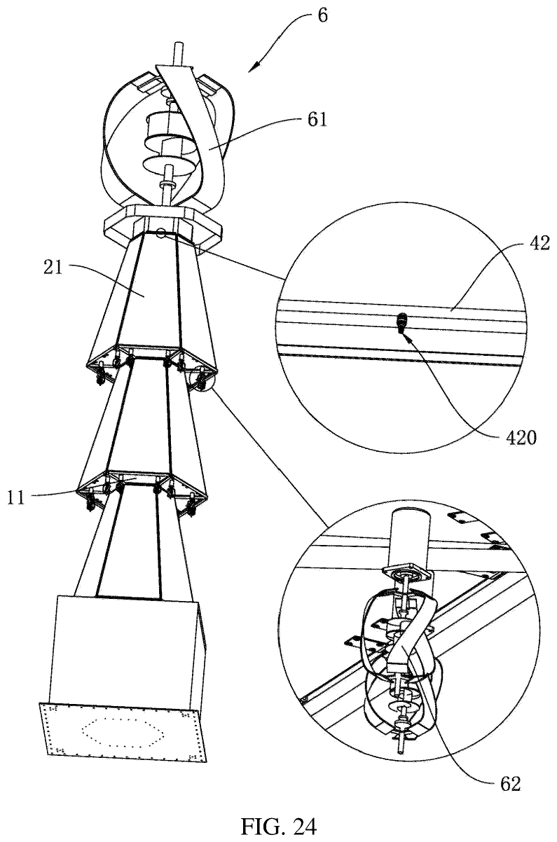

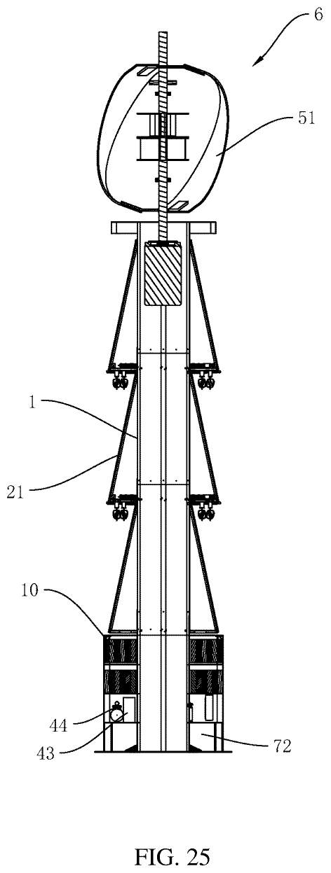

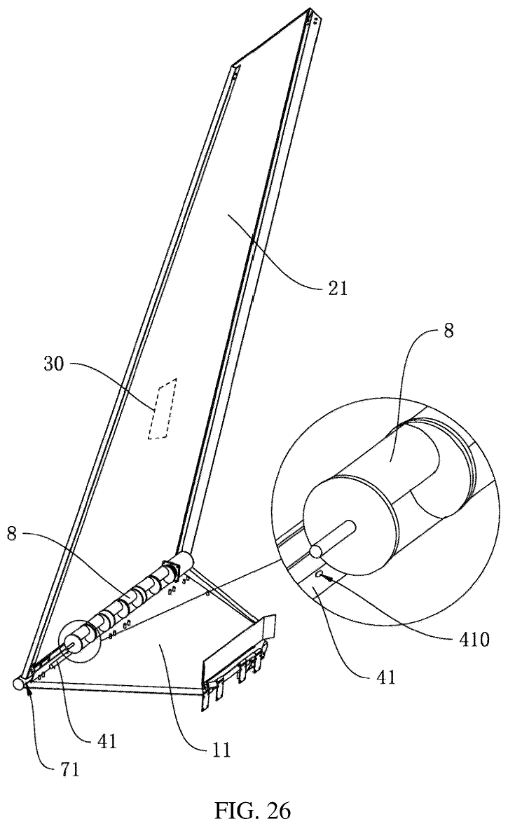

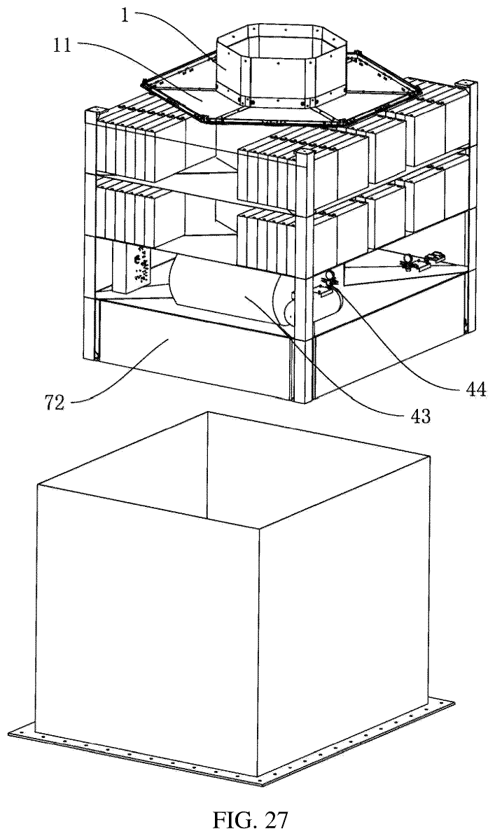

In an embodiment, as shown in FIGS. 23-27, the energy conversion apparatus further includes at least a ventilation and exhaust mechanism, a battery pack 10 and the photovoltaic units 21 mounted on the main pole 1, where the ventilation and exhaust mechanism includes at least a first air duct 41 arranged on an inner side of the photovoltaic unit 21, and the first air duct 41 is provided with at least a first air vent 410 configured to blow wind toward an inner surface of the photovoltaic unit 21. The ventilation and exhaust mechanism further includes an air compressor 44 connected to the first air duct 41 and an air storage tank 43 configured to store the air discharged by the air compressor 44, the air storage tank 43 is provided with an electric valve 431 configured to discharge the air in the air storage tank 43 to the first air duct 41. An outer side of the photovoltaic unit 21 is provided with a first wind power generation device 6, and the inner side of the photovoltaic unit 21 is provided with at least a second wind power generation device 8 configured to generate electricity by using the wind blown from the first air vent 410. The energy conversion apparatus further includes a control system configured to control the air compressor 44 to store air into the air storage tank 43 and control opening of the electric valve 431 to release the air in the air storage tank 43, and the air compressor 44 and the electric valve 431 are electrically connected to the control system. The electric energy generated by the photovoltaic units 21, the first wind power generation device 6, and the second wind power generation device 8 is stored in the battery pack 10.

The present disclosure generates electricity through wind energy and solar energy, and also pre-stores wind energy in the air storage tank 43, and when external wind energy is insufficient, the compressed air in the air storage tank 43 is released to blow toward the second wind power generation device 8 for electricity generation.

In an example, the second wind power generation device 8 is a single-motor wind generator or a dual-motor wind generator, when the second wind power generation device 8 is the single-motor wind generator and when a temperature sensor detects that the temperature of the photovoltaic unit 21 is higher than a preset threshold, the control system controls the electric valve 431 to release the compressed air in the air storage tank 43 to drive fan blades of the second wind power generation device 8 and push wind upward to the photovoltaic unit 21 for better heat dissipation, and the electric energy generated by the rotation of the fan blades of the second wind power generation device 8 is stored in the battery pack 10; and when the second wind power generation device 8 is the dual-motor wind generator, the electric energy output by the battery pack 10 causes one of the motors to rotate the fan blades to send the wind to the photovoltaic unit 21 for better heat dissipation, and the other motor rotates to generate electric energy that is stored back into the battery pack 10, thereby realizing the recycling of wind energy.

In an example, the first wind power generation device 6 and the second wind power generation device 8 are both breeze-activated wind turbines that generate electricity by driving the fan blades with breeze, and when the breeze blows toward the fan blades of the first wind power generation device 6 and the second wind power generation device 8, power generation is started.

At least a water collection gutter 71 and at least a water storage tank 72 configured to collect water are arranged below the photovoltaic unit 21, the water collection gutter 71 is higher than the water storage tank 72, at least a water inlet pipe 73 configured to discharge water in the water collection gutter 71 to the water storage tank 72 is arranged between the water collection gutter 71 and the water storage tank 72, and the water inlet pipe 73 is provided with at least a hydroelectric generator 74 to collect rainwater during rainy days for power generation. The hydroelectric generator 74 is a hydropower generating vehicle or a hydro turbine generator set.

In an example, the air compressor 44 is provided with a water-gas separator 441, and water separated by the water-gas separator 441 flows into the water storage tank 72 through a conduit. The water-gas separator is a gravity separator, a centrifugal separator, a bubble tower, a wet cyclone separator, or the like, and under high-humidity conditions, the separated water flows into the water storage tank 72 for reuse.

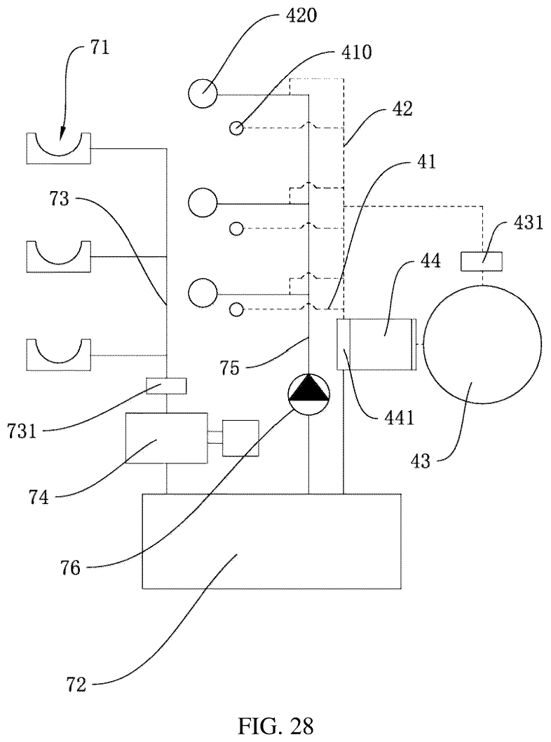

In an example, as shown in FIG. 28, the ventilation and exhaust mechanism further includes a second air duct 42 located outside the photovoltaic unit 21 and connected to an air outlet of the electric valve 431, the second air duct 42 is provided with at least a second air vent 420 that blows wind toward an outer surface of the photovoltaic unit 21, a drainage pipe 75 connecting the water storage tank 72 and the second air duct 42 is provided therebetween, and the drainage pipe 75 is provided with a water pump 76 configured to pump water from the water storage tank 72 to the second air duct 42. The electric valve 431 may be a four-position three-way solenoid valve, and the air storage tank 43, the first air duct 41, and the second air duct 42 are connected to three switching flow ports of the four-position three-way solenoid valve.

When the outer surface of the photovoltaic unit 21 is dirty, the compressed air in the air storage tank 43 is released separately and blown out from the second air vent 420 to clean the photovoltaic unit, or when wind is blown through the second air vent 420, the water in the water storage tank 72 is pumped into the second air duct 42 by the water pump 76 to cooperatively clean the photovoltaic unit 21. A part of water after the cleaning alternatively flows back into the water storage tank 72 through the water collection gutter 71 and the water inlet pipe 73 for reuse.

In an example, a primary filter mechanism 731 configured to filter impurities in water is arranged on the water inlet pipe 73, and the primary filter mechanism 731 is arranged at a water inlet end of the hydroelectric generator 74, to prevent some impurities from entering the hydroelectric generator 74 and avoid damaging the hydroelectric power generation device. The primary filter mechanism 731 is a filter mesh, a filter cartridge, or any other filter structure detachably replaced.

In an example, the first wind power generation device 6 includes a main wind turbine generator 61 arranged at the top of the main pole 1 and an auxiliary wind turbine generator 62 arranged below the assembly plates 11. In an example, the auxiliary wind turbine generator 62 is arranged on both left and right sides below the assembly plates 11, such that the energy storage device collects wind energy from all directions. The main wind turbine generator 61 and the auxiliary wind turbine generator 62 are both mounted through threaded fasteners or other mounting means.

In an example, energy for the battery pack 10 includes electric energy generated through photovoltaic conversion of solar energy by the photovoltaic units 21, electric energy generated through wind energy conversion by the first wind power generation device 6 and the second wind power generation device 8, and electric energy generated by the hydroelectric generator 74.

Water in the water storage tank 72 includes: atmospheric precipitation, ambient moisture, or other collectible water sources, as well as water separated by the water-gas separator 441 during the operation of the air compressor 44, and water recovered during cleaning.

Energy for the air storage tank 43 includes: wind energy, which is converted into mechanical energy through the air compressor 44, where the compressed air is stored in the air storage tank 43.

The above battery pack 10 is configured to store the electricity generated by the wind-solar-hydro power generation system, and the stored electric energy is released in case of insufficient solar irradiation, reduced wind velocity, or peak electricity demand to ensure stable power supply. The water collected by the water collection gutter 71 flows into the water storage tank 72 through the water inlet pipe 73, which drives the hydroelectric generator 74 to generate electricity. Additionally, the water separated from the air compressor 44 also flows back into the water storage tank 72, which achieves water recycling. During the grid load valley period or when cleaning the photovoltaic unit 21 for cooling is needed, the control system controls opening of the electric valve 431 to release the compressed air in the air storage tank 43. On the one hand, the compressed air is blown toward the photovoltaic unit 21 through the first air vent 410 to achieve cleaning and cooling. On the other hand, the second air duct 42 is communicated with the water storage tank 72, and the compressed air mixed with water is sprayed out, which enhances the cleaning effect and cools the surface of the photovoltaic unit 21. Additionally, the wind energy blown from the first air vent 410 to the photovoltaic unit 21 to achieve cleaning and cooling also drives the second wind power generation device 8 to convert the wind energy into electric energy, thereby achieving energy recycling.

Light received by the photovoltaic units 21 is converted into electric energy and stored in the battery pack 10, and wind energy is converted into electric energy by the first wind power generation device 6 and stored in the battery pack 10; electric energy generated by the hydroelectric generator 74 is stored in the battery pack 10; the control system controls the air compressor 44 to compress and store air in the air storage tank 43, and when the electric energy generated by conversion of light received by the photovoltaic units 21 and the electric energy generated by the first wind power generation device 6 through wind energy conversion are insufficient, the control system controls opening of the electric valve 431 to release the compressed air in the air storage tank 43 and blow same toward the second wind power generation device 8 to generate electricity, and the generated electric energy is stored in the battery pack 10; when the sensor detects that the temperature of the photovoltaic unit 21 reaches a preset threshold or the dust level reaches a preset threshold, the control system controls the opening of the electric valve 431 to blow wind toward the photovoltaic unit 21 to cool or clean the photovoltaic unit 21; and moreover, the second wind power generation device 8 also collects the wind energy blown out from the first air vent 410 to generate and store electric energy in the battery pack 10, the water used for cleaning flows back into the water storage tank 72 through the water collection gutter 71, and water recovery enables to generate electricity through the hydroelectric generator 74, thereby realizing energy recycling.

A control method for energy conversion apparatus capable of automatic light compensation and light recycling is provided:

The photovoltaic module 2 is correspondingly provided with a photosensitive unit configured to detect the light intensity received by each of the photovoltaic units 21, and the control system is electrically connected to the photovoltaic module 2, the light compensation modules 9, and the photosensitive unit, and controls the photovoltaic module 2, the light compensation modules 9, and the photosensitive unit to operate;
the photosensitive unit transmits a detected light intensity signal to the control system;
when the photovoltaic module receives a certain amount of sunlight, but the light intensities received by all the photovoltaic units 21 are lower than a preset light activation threshold A, the control system controls the light compensation module 9 corresponding to the photovoltaic units 21 in the photovoltaic module to operate such that the light intensity received by each of the photovoltaic units 21 in the photovoltaic module reaches the light activation threshold A, so as to effectively utilize sunlight for electricity generation; the light activation threshold A is greater than a minimum light intensity required for the photovoltaic units to operate, and is less than a conversion light intensity B required for the photovoltaic units 21 to achieve a conversion rate m, where the conversion rate m is the optimal conversion rate currently achievable to a single photovoltaic unit in the prior art, preferably, m ranges from 13% to 27%, and it is contemplated that the conversion rate m may exceed this range with the continuous advancements in photovoltaic unit technology;
when the light intensity received by some the photovoltaic units 21 in the photovoltaic module is lower than the preset light activation threshold A, while the light intensity received by other photovoltaic units 21 is equal to or greater than the light activation threshold A, the control system controls the corresponding light compensation modules 9 to perform light compensation for the photovoltaic units 21 with the light intensity lower than the light activation threshold A, so as to balance the light intensity received by different photovoltaic units 21 in the photovoltaic module and improve the energy conversion rate; and
when the light intensities received by all the photovoltaic units 21 in the photovoltaic module are greater than the preset light activation threshold A, but the light intensities received by some or all of the photovoltaic units 21 are less than the conversion light intensity B required for the photovoltaic units 21 to achieve the conversion rate m, the control system controls the corresponding light compensation modules 9 to perform light compensation for the photovoltaic units 21 with the light intensity lower than the preset conversion light intensity B, such that the light intensity received by each of the photovoltaic units 21 in the photovoltaic module reaches the preset conversion light intensity B, so as to balance the light intensity received by different photovoltaic units 21 in the photovoltaic module, improve the energy conversion rate, and ensure that the photovoltaic module achieves higher conversion efficiency.

The “balance” mentioned herein does not mean equalizing the light intensity of each of the photovoltaic units 21, but means narrowing the light intensity difference between different photovoltaic units 21 in the photovoltaic module such that the light intensities of these photovoltaic units 21 are at or close to the same level, and for example, all the light intensities reach the light activation threshold A or the light intensity required for the conversion light intensity B.

The light activation threshold A and the conversion light intensity B preset in the control system are determined experimentally through testing of the energy conversion apparatus capable of automatic light compensation and light recycling.

In a predetermined time period at night, the control system directly controls the light compensation module to achieve nighttime illumination. Since the light compensation module simultaneously illuminates upward and downward, in order to recycle the light emitted by the light compensation module, the photovoltaic unit 21 equipped with the light compensation module 9 is provided with at least a channel for the light emitted by the light compensation module 9 to irradiate a reverse side thereof, the light compensation module 9 is arranged on the reverse side of the photovoltaic unit 21 and irradiates the reverse side of the photovoltaic unit 21. The light directed downward by the light compensation module 9 irradiates the front side of the photovoltaic unit below, the light compensation module 9 is located on the reverse side of the photovoltaic unit 21 and irradiates the reverse side of the photovoltaic unit 21, the front and reverse faces of the photovoltaic unit 21 are both light-transmissive and absorb light, and the light emitted by the light compensation module is fully utilized and recycled for conversion into electric energy.

In the present disclosure, the light emitted downward by the light compensation module is used for nighttime illumination, the lower photovoltaic units also perform recycling of illuminating rays, the light directed to the reverse side of the photovoltaic unit is recycled by the photovoltaic unit, and part of the light is transmitted out of the photovoltaic unit through areas not covered by cells of the photovoltaic unit, thereby achieving an artistic landscape effect.

In an example, at least a ventilation and exhaust mechanism and a battery pack are arranged, where the ventilation and exhaust mechanism includes at least a first air duct 41 arranged on an inner side of the photovoltaic unit 21, and the first air duct 41 is provided with at least a first air vent 410 configured to blow wind toward an inner surface of the photovoltaic unit 21. The ventilation and exhaust mechanism further includes an air compressor 44 connected to the first air duct 41 and an air storage tank 43 configured to store the air discharged by the air compressor 44, the air storage tank 43 is provided with an electric valve 431 configured to discharge the air in the air storage tank 43 to the first air duct 41. An outer side of the photovoltaic unit 21 is provided with a first wind power generation device 6, and the inner side of the photovoltaic unit 21 is provided with at least a second wind power generation device 8 configured to generate electricity by using the wind blown from the first air vent 410. The energy conversion apparatus further includes a control system configured to control the air compressor 44 to store air into the air storage tank 43 and controls opening of the electric valve 431 to release the air in the air storage tank 43, and the air compressor 44 and the electric valve 431 are electrically connected to the control system. The first wind power generation device 6 is provided with at least a wind speed sensor configured to detect the ambient wind speed, the wind speed sensor is electrically connected to the control system, and the wind speed sensor is a mechanical wind speed sensor, an ultrasonic wind speed sensor, a thermal wind speed sensor, a vibration-type wind speed sensor, or the like.

Light received by the photovoltaic units 21 is converted into electric energy and stored in the battery pack 10, and wind energy is converted into electric energy by the first wind power generation device 6 and stored in the battery pack 10; the battery pack 10 supplies electrical power to the air compressor 44 and the electric valve 431, and the control system controls the air compressor 44 to compress and store air in the air storage tank 43; and
the first wind power generation device 6 and the second wind power generation device 8 are both breeze-start wind turbines, when the wind speed sensor detects that the ambient wind speed is lower than a preset threshold, the control system controls opening of the electric valve 431 to release the compressed air in the air storage tank 43 and blow toward the first wind power generation device 6 through the air duct, such that the first wind power generation device 6 supplements electric energy for the battery pack 10; and fan blades of the second wind power generation device 8 are driven to rotate by the wind blown out from the first air vent 410 to generate electricity to be stored in the battery pack 10.

In an example:

The energy conversion apparatus collects atmospheric precipitation through at least a water collection gutter 71 arranged below the photovoltaic unit 21, and when the water in the water inlet pipe 73 flows to the water storage tank 72, the water flow drives the hydroelectric generator 74 to rotate, and the hydroelectric generator 74 generates electric energy to be stored in the battery pack 10; and
the air compressor 44 is provided with a water-gas separator 441, and water separated by the water-gas separator 441 from intake air flows into the water storage tank 72 through a conduit.

In an example:
the ventilation and exhaust mechanism further includes a second air duct 42 located outside the photovoltaic unit 21 and connected to an air outlet of the electric valve 431, the second air duct 42 is provided with at least a second air vent 420 that blows wind toward an outer surface of the photovoltaic unit 21, a drainage pipe 75 connecting the water storage tank 72 and the second air duct 42 is arranged therebetween, the drainage pipe 75 is provided with a water pump 76 configured to pump water from the water storage tank 72 to the second air duct 42, and the battery pack 10 supplies electrical power to the water pump 76; the control system directly controls opening of the electric valve 431 to release the compressed air in the air storage tank 43 and blow toward the outer surface of the photovoltaic unit 21 through the second air vent 420 for cleaning; alternatively, the control system controls the water pump 76 to draw water from the water storage tank 72 into the second air duct 42, cooperating with the compressed air released from the air storage tank 43 to blown toward the outer surface of the photovoltaic unit 21 for cleaning; and

The energy storage device further includes a timer, the timer is electrically connected to the control system, and when a preset time interval of the timer expires, the control system controls opening of the electric valve 431 to release the compressed air in the air storage tank 43 and blow toward the outer surface of the photovoltaic unit 21 through the second air duct 42 for cleaning.

In an example:

The photovoltaic unit 21 is provided with at least a temperature sensor 30 configured to, connect to the control system electrically, and when the temperature sensor 30 detects that the temperature reaches a preset threshold, the control system controls opening of the electric valve 431 to release the compressed air in the air storage tank 43 and blow out from the first air vent 410 to perform heat dissipation for the photovoltaic unit 21; and the second wind power generation device 8 receives the wind blown out from the first air vent 410 to generate electricity to be stored in the battery pack 10 The temperature sensor 30 is a thermocouple, a thermistor, a resistance temperature detector, an IC temperature sensor, or the like.

In an example:

The photovoltaic unit 21 is provided with at least a dust sensor connected to the control system electrically, and when the dust sensor detects that the dust level reaches a preset threshold, the control system controls opening of the electric valve 431 to release the compressed air in the air storage tank 43 and blow out from the second air vent 420 to clean the photovoltaic unit 21; the dust sensor may is a laser dust sensor, a photoelectric dust sensor, an inductive dust sensor, an ultrasonic dust sensor, or the like;
when the dust sensor detects that the dust level reaches the preset threshold, the control system controls opening of the electric valve 431 to release the compressed air in the air storage tank 43 and blow toward the photovoltaic unit 21 from the second air vent 420, and controls the water pump 76 to pump water from the water storage tank 72 into the second air duct 42, cooperating the compressed air released from the air storage tank 43 to blown toward the outer surface of the photovoltaic unit 21 for cleaning; and
the water used for cleaning the photovoltaic unit 21 flows into the water collection gutter 71 along the surface of the photovoltaic unit 21, the water in the water collection gutter 71 flows to the water storage tank 72 through the water inlet pipe 73, the water flow drives the hydroelectric generator 74 to rotate, and the hydroelectric generator 74 generates electric energy to be stored in the battery pack 10; and the hydroelectric generator 74 is a hydropower generating vehicle or a hydro turbine generator set.

What is claimed is:

1. An energy conversion apparatus capable of automatic light compensation and light recycling, is characterized by comprising at least a main pole (1) and a plurality of light compensation modules (9), the main pole (1) is provided with a plurality of photovoltaic modules (2) along with a length thereof, each of the photovoltaic modules (2) includes a plurality of photovoltaic units (21) arranged around an outer side of the main pole (1), the photovoltaic units (21) are configured to convert light energy into electric energy, the light compensation modules (9) perform light compensation for photovoltaic units (21) of the photovoltaic modules (2) where light intensity is lower than a preset threshold to balance the light intensity received by each of the photovoltaic units (21) of the photovoltaic modules (2), the light compensation modules (9) are electrically connected to a control system configured to control the light compensation modules to start the light compensation, and the photovoltaic units (21) are electrically connected to the control system.

2. The energy conversion apparatus capable of automatic light compensation and light recycling according to claim 1, wherein each of the photovoltaic units (21) is arranged to tilt outward and upward, and an upper end of a lower photovoltaic unit (21) is located on an inner side of a lower end of an upper photovoltaic unit (21).

3. The energy conversion apparatus capable of automatic light compensation and light recycling according to claim 2, wherein the main pole (1) is provided with assembly plates (11), a lower end of the photovoltaic unit (21) is mounted on an assembly plate (11).

4. The energy conversion apparatus capable of automatic light compensation and light recycling according to claim 3, wherein an upper end of the photovoltaic unit (21) is directly or indirectly rotatably connected to the main pole (1), and the lower end of the photovoltaic unit (21) is detachably mounted on the assembly plate (11).

5. The energy conversion apparatus capable of automatic light compensation and light recycling according to claim 3, wherein the assembly plate (11) of the upper photovoltaic unit (21) is provided with at least one light compensation module (9) configured to illuminate a front face of the lower photovoltaic unit (21) to compensate light for the lower photovoltaic unit (21), a top of the main pole (1) is provided with a top cover (5), and the top cover (5) is provided with at least one light compensation module (9) configured to illuminate the front face of the lower photovoltaic unit (21) to achieve light compensation.

6. The energy conversion apparatus capable of automatic light compensation and light recycling according to claim 4, wherein the assembly plate (11) of the upper photovoltaic unit (21) is provided with at least one light compensation module (9) configured to illuminate a front face of the lower photovoltaic unit (21) to compensate light for the lower photovoltaic unit (21), a top of the main pole (1) is provided with a top cover (5), and the top cover (5) is provided with at least one light compensation module (9) configured to illuminate the front face of the lower photovoltaic unit (21) to achieve light compensation.

7. The energy conversion apparatus capable of automatic light compensation and light recycling according to claim 2, wherein the photovoltaic unit (21) equipped with the light compensation module (9) is provided with at least a channel for light emitted by the light compensation module (9) to illuminate a reverse side thereof, the light compensation module (9) is arranged on the reverse side of the photovoltaic unit (21) and is configured to illuminate towards the reverse side of the photovoltaic unit (21), and front side and reverse side of the photovoltaic unit (21) are both light-transmissive and absorb light energy to convert same into electric energy.

8. The energy conversion apparatus capable of automatic light compensation and light recycling according to claim 7, wherein the front side of the photovoltaic unit (21) is a light-transmissive glass plate, the reverse side of the photovoltaic unit (21) is also a light-transmissive glass plate, and cells of the photovoltaic unit (21) are located between the glass plates; or the front side of the photovoltaic unit (21) is a light-transmissive glass plate, the reverse side of the photovoltaic unit (21) is a light-transmissive film, and the cells of the photovoltaic unit (21) are located between the glass plate and the film.

9. The energy conversion apparatus capable of automatic light compensation and light recycling according to claim 1, wherein the photovoltaic module (2) is correspondingly provided with photosensitive units configured to detect light intensity received by each of the photovoltaic units (21), the light compensation module (9) includes a plurality of LED lighting modules with different powers, and the control system is electrically connected to the photosensitive units and controls the light compensation module (9) to emit light of corresponding light intensity according to the light intensity transmitted by the photosensitive units.

10. The energy conversion apparatus capable of automatic light compensation and light recycling according to claim 8, wherein a gap (20) is formed between two adjacent photovoltaic units (21), and a light guide assembly (3) configured to refract light to the reverse face of the photovoltaic unit (21) to achieve light absorption on the reverse face is mounted inside the gap (20), the light guide assembly (3) includes at least a condensing lens (310) or at least a light-directing lens (311) configured to refract light entering the gap (20) to a reverse face of the double-sided glass plate of the photovoltaic unit (21), further including a frame (200), wherein the photovoltaic unit (21) and the light guide assembly (3) are fixed to the frame (200), and each light guide assembly (3) is provided with a light-receiving surface (300) exposed from the left and right sides of the photovoltaic unit (21) to receive light incident from the gap (20) between the left and right photovoltaic units (21).

11. The energy conversion apparatus capable of automatic light compensation and light recycling according to claim 2, wherein the photovoltaic unit (21) is attached and fixed to a surface of the main pole (1).

12. The energy conversion apparatus capable of automatic light compensation and light recycling according to claim 11, wherein the main pole (1) has an integrated structure.

13. The energy conversion apparatus capable of automatic light compensation and light recycling according to claim 11, wherein the main pole (1) is assembled from a number of pole segments (12) fitted together end-to-end, an outer side face of the pole segment (12) is provided with at least a mounting frame (13), and the photovoltaic unit (21) is mounted on the mounting frame (13).

14. The energy conversion apparatus capable of automatic light compensation and light recycling according to claim 13, wherein each of the pole segments (12) has a conical structure enlarged from top to bottom, an upper end of a lower pole segment (12) is inserted into a bottom hole of an upper pole segment (12), and the mounting frames of the upper and lower pole segments (12) are fixed by screws after sleeved connection.

15. The energy conversion apparatus capable of automatic light compensation and light recycling according to claim 2, wherein upper and lower ends of a plurality of the photovoltaic units (21) in one layer are provided with connectors (22) for connecting and fixing the plurality of photovoltaic units (21) to form one photovoltaic module (2), a middle part of the photovoltaic module (2) is provided with a through hole (23) into which the main pole (1) is sleeved, and the main pole (1) is vertically sleeved with a plurality of photovoltaic modules (2).

16. The energy conversion apparatus capable of automatic light compensation and light recycling according to claim 2, wherein at least a side of the photovoltaic unit (21) is detachably provided with at least a reinforcement strip (100) configured to press the photovoltaic unit (21) against falling off.

17. The energy conversion apparatus capable of automatic light compensation and light recycling according to claim 1, further comprising at least a ventilation and exhaust mechanism and a battery pack (5), wherein the ventilation and exhaust mechanism includes at least a first air duct (41) arranged on an inner side of the photovoltaic unit (21), and the first air duct (41) is provided with at least a first air vent (410) configured to blow wind toward an inner surface of the photovoltaic unit (21); the ventilation and exhaust mechanism further includes an air compressor (44) connected to the first air duct (41) and an air storage tank (43) configured to store air discharged by the air compressor (44), the air storage tank (43) is provided with an electric valve (431) configured to discharge air in the air storage tank (43) to the first air duct (41); an outer side of the photovoltaic unit (21) is provided with a first wind power generation device (6), and the inner side of the photovoltaic unit (21) is provided with at least a second wind power generation device (8) configured to generate electricity by using wind blown from the first air vent (410); the energy conversion apparatus further includes a control system configured to control the air compressor (44) to store air into the air storage tank (43) and control opening of the electric valve (431) to release air in the air storage tank (43), and the air compressor (44) and the electric valve (431) are electrically connected to the control system.

18. The energy conversion apparatus capable of automatic light compensation and light recycling according to claim 17, wherein at least a water collection gutter (71) and at least a water storage tank (72) configured to collect water are arranged below the photovoltaic unit (21), the water collection gutter (71) is higher than the water storage tank (72), at least a water inlet pipe (73) configured to discharge water in the water collection gutter (71) to the water storage tank (72) is arranged between the water collection gutter (71) and the water storage tank (72), and the water inlet pipe (73) is provided with at least a hydroelectric generator (74).

19. The energy conversion apparatus capable of automatic light compensation and light recycling according to claim 18, wherein the air compressor (44) is provided with a water-gas separator (441), and water separated by the water-gas separator (441) flows into the water storage tank (72) through a conduit.

20. The energy conversion apparatus capable of automatic light compensation and light recycling according to claim 18, wherein the ventilation and exhaust mechanism further includes a second air duct (42) located outside the photovoltaic unit (21) and connected to an air outlet of the electric valve (431), the second air duct (42) is provided with at least a second air vent (420) that blows wind toward an outer surface of the photovoltaic unit (21), a drainage pipe (75) connecting the water storage tank (72) and the second air duct (42) is provided therebetween, and the drainage pipe (75) is provided with a water pump (76) configured to pump water from the water storage tank (72) to the second air duct (42).
